(19) United States
(12) Patent Application Publication
(10) Pub. No.: US 2008/0235605 A1
(43) Pub. Date: Sep. 25, 2008

(54) METHOD AND SYSTEM TO AUTOMATE A USER OUT OF A PROCESS FLOW

(76) Inventor: Robert T. Uthe, Morrisville, NC (US)

Correspondence Address: MOORE & VAN ALLEN, PLLC For IBM, P.O. Box 13706, Research Triangle Park, NC, 27709, US

(21) Appl. No.: 11/688,319

(22) Filed: Mar. 20, 2007

(51) Int. Cl. G06F 3/048

(52) U.S. Cl. 715/764; 715/700

(57) ABSTRACT

A method to automate a user out of a process flow may include determining if a process template associated with the process flow is available or exists. The process template may include one of a user interface, form or the like. The method may also include determining if a rule exists for automatic completion of at least a portion of the process template to automate the user at least partially out of the process flow. The method may further include at least partially completing the process template automatically without user input in response to an existing rule for the process template, wherein the process template is automatically populated based on a content of the existing rule.

### BACKGROUND OF THE INVENTION

The present invention relates to processes that may involve user or human interaction, and more particularly to a method and system to automate a user out of a process flow.

Today's process based tools such as Information Technology Service Management (ITSM) and similar process based tools have an ability to seamlessly integrate human interactions in a process flow along with under-the-covers system processing. In this manner a user can be asked to approve a change, provide a test plan document, make decisions or selections, or provide other inputs. The process tool may then function to fulfill its part of the process to deploy software, initiate a system backup, or to perform some other function. When a user is asked to perform a task during a process flow a request may materialize on the user's “to do” list, “in box” or be sent to the user by some other means. The user may pick a task to run out of their “to do” list. A user interface (UI) for this task may then be presented to the user to describe the requested task as well as allow the user to provide any needed information to complete the task or satisfy the request. In practice a user interface may be presented as some type of form. The form will typically include a set of entry fields for data or information to be entered by the user. One potential source of errors in such a process may be inputs by the user. User errors when inputting data may introduce errors into the data used during the process flow. Additionally, a user's inability to instantaneously respond to a given to-do list item means the process is almost always in a wait state for the user to complete a given task or process step.

### BRIEF SUMMARY OF THE INVENTION

In accordance with an embodiment of the present invention, a method to automate a user out of a process flow may include determining if a process template associated with the process flow is available or exists. The process template may include a user interface, form or the like. The method may also include determining if a rule exists for automatic completion of at least a portion of the process template to automate the user at least partially out of the process flow. The method may further include at least partially completing the process template automatically without user input in response to an existing rule for the process template, wherein the process template is automatically populated based on a content of the existing rule.

In accordance with another embodiment of the present invention, a system to automate a user out of a process flow may include a processor and a module operable on the processor to select a process template based on a task. The process template may include a user interface, form or the like. The system may also include a module to at least partially complete the process template automatically in response to an existing rule for the process template and to automatically populate the process template based on a content of the existing rule.

In accordance with another embodiment of the present invention, a computer program product to automate a user out of a process flow may include a computer usable medium having computer usable program code embodied therein. The computer usable medium may include computer usable program code configured to determine if a process template associated with the process flow is available or exists. The computer useable medium may also include computer usable program code configured to determine if a rule exists for automatic completion of at least a portion of the process template to automate the user at least partially out of the process flow. The computer useable medium may further include computer usable program code configured to at least partially complete the process template automatically without user input in response to an existing rule for the process template, wherein the process template is automatically populated based on a content of the existing rule.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A, 1B and 1C each illustrate an example of a process template that includes a feature to automate a user at least partially out a process flow and to automatically complete at least a portion of the process flow or template in accordance with an embodiment of the present invention.

FIG. 2 is an illustration of an example of a graphical user interface to create, edit and control activation of one or more rules for automating a user at least partially out of a process flow and for automatically completing at least a portion of the process flow or template in accordance with an embodiment of the present invention.

FIG. 3 is an illustration of an example of a graphical user interface to create or edit a rule for automating a user at least partially out of a process flow and for automatically completing at least a portion of the process flow or template in accordance with an embodiment of the present invention.

FIG. 4 is a flow chart of an example of a method to automate a user at least partially out of a process flow and to automatically complete at least a portion of the process flow or template in accordance with an embodiment of the present invention.

FIG. 5 is a block diagram of an example of a system to automate a user at least partially out of a process flow and to automatically complete at least a portion of the process flow or template in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

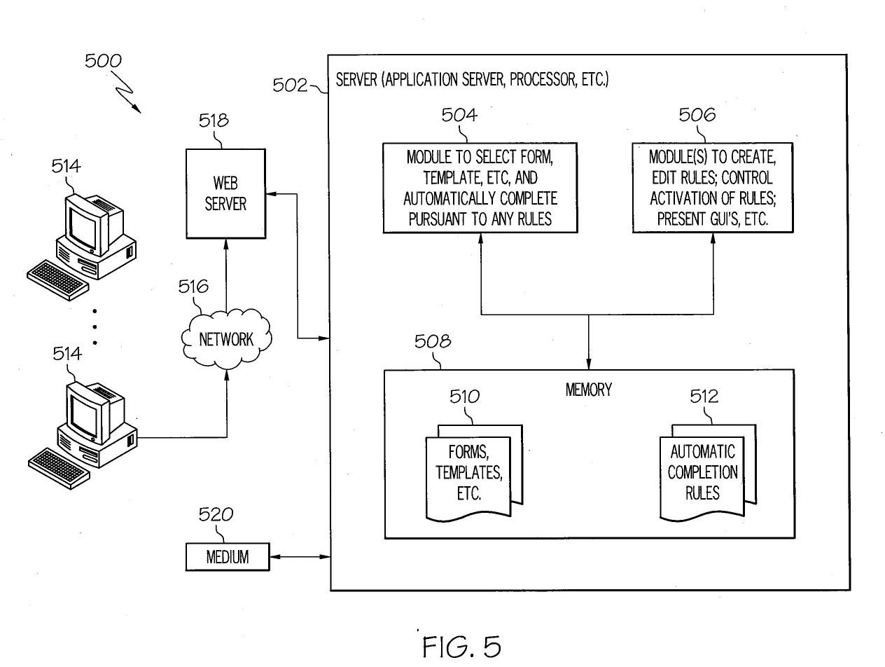

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium, such as for example medium 520 in FIG. 5, having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

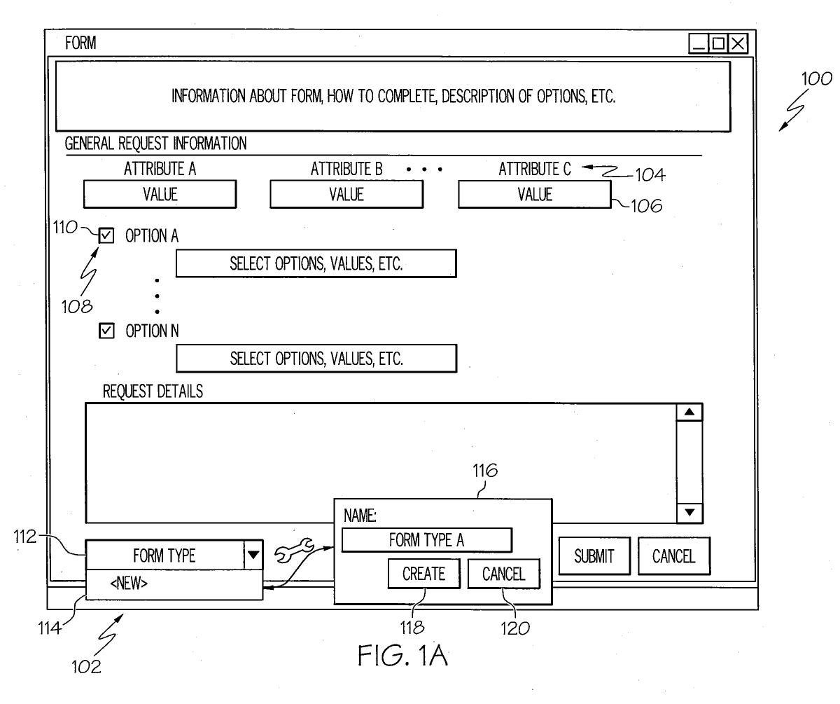

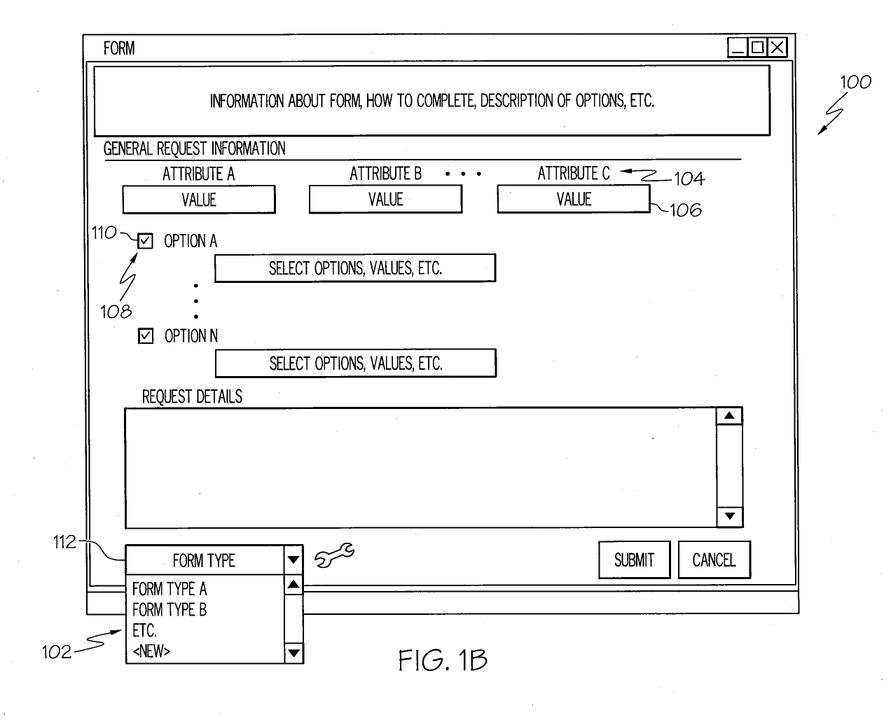

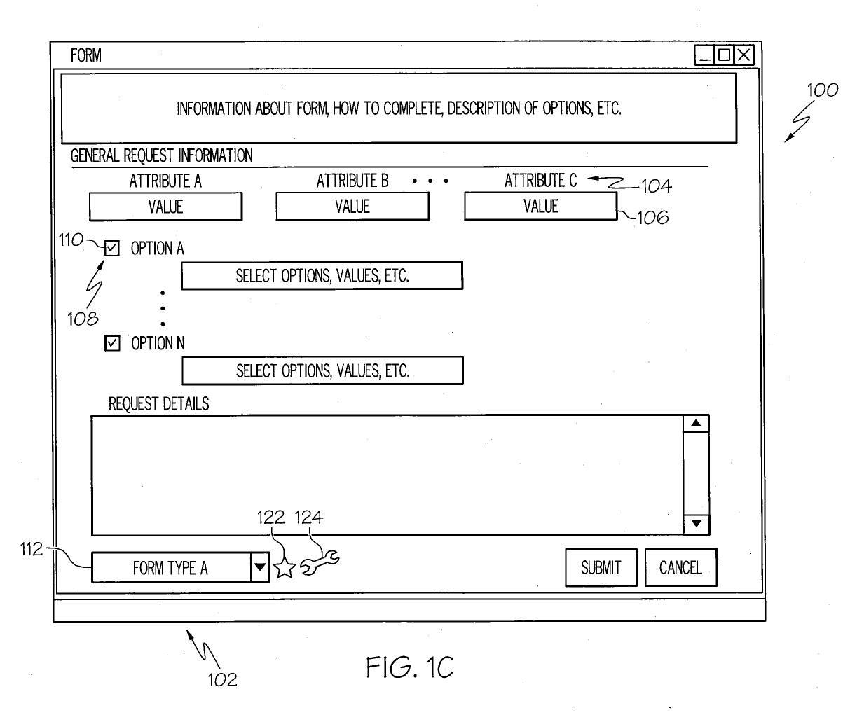

FIGS. 1A, 1B and 1C each illustrate an example of a process template 100 that includes a feature 102 to automate a user at least partially out a process flow and to automatically complete at least a portion of the process flow or template 100 in accordance with an embodiment of the present invention. The process template 100 may be a form that may be completed by a user as part of a process flow to complete a task, satisfy a request, or to perform some other service or realize some result. The process template 100 may include one or more attributes 104. Each attribute 104 may include a field 106 or block in which a value may be entered that is associated with the attribute 104. While each attribute 104 and field value 106 appear only as a simple entry field in FIG. 1A, in practice these attributes and fields could be any form of input field including but not limited to text, text area, password, selectable list box, dropdown chooser, spin button or other types attributes or fields. The process template 100 may also include one or more options 108 that may be selected as part of a process flow or completion of the process template 100. The process template 100 may also include control objects 110, such as check boxes, radio buttons or similar means, to select or control certain operations or functions associated with the process flow.

After a user has completed the process template 100 or completed selected portions of the process template 100, the feature 102 to automate a user at least partially out a process flow and to automatically complete at least a portion or selected portions of the process flow or template 100 may be used. The automate out feature or automatic completion feature 102 may include a drop down menu 112 or other selection feature to capture or save the process template 100 as completed or partially completed as a “form template” for subsequent uses or applications. The drop down menu 112 may include a “<new>” option 114 or similar indication to create or define and capture a new form template. If the <new> option 114 is selected by a user using a computer pointing device or by other means, a dialogue box 116 or the like may be presented for the user to enter a name or identification for the new form template. A button 118 that may be labeled “Create” or some other descriptive label may be presented in the dialogue box 116. The create button 118 may be operated by the user or clicked-on using a computer pointing device to create, capture or save the process template 100 as completed as a new type of form template. Another button 120 that may be labeled “Cancel” may also be presented in the dialogue box 116 adjacent to the Create button 118. The Cancel button 120 may be operated or clicked-on by the user if the user decides not to save the template 100 as a new form template for subsequent use.

Referring to FIG. 1B, when the process template 100 is subsequently used or selected in response to a particular task or request, a user may click-on or activate the drop-down menu 112 to display the names or identification of any form templates that may have been previously captured or saved in the system, such as the system 500 of FIG. 5. The user may also complete or partially complete the process template 100 and then select the “<new>” option to create another new form template similar to that described with respect to FIG. 1A. Another example of creating and saving a form template is described in U.S. patent application Ser. No. 11/233885, entitled “Smart Form Completion of Form Values” by Robert Uthe, filed 23 Sep. 2005, assigned to the same assignee as the present application, and incorporated herein in its entirety by reference.

If the user selects one of the previously created form templates by clicking-on the name or identification for the desired form template in the drop-down list or menu 112 using a computer pointing device or by some other means, the current form or process template 100 will be updated in accordance with the captured or saved form template as illustrated in FIG. 1C. As described in more detail herein, values for attribute fields, selection of options and the like may be automatically entered or completed in the process template 100 based on any predefined rule or rules.

In addition, the first time the form or process template 100 is presented to the user a rule or rules will be evaluated to see if a saved form template should be used automatically. If so, the form or process template 100 will be updated in accordance with the captured or saved form template as illustrated in FIG. 1C. An indicator 122 may be presented in the process template 100 that the user has been automated at least partially out of the process flow and that the process template 100 has been at least partially automatically completed based on any existing predefined rule or rules. In the example of the process template 100 illustrated in FIG. 1C, the indicator 122 may be a star but any indicator to indicate that the process template 100 has been automatically completed may be used. In addition, the dropdown list at 112 will show the name of the captured or saved form template called out by the rule or rules. Any rules used to select the appropriate process template 100 or substantially complete the template 100 may be presented in response to contacting or hovering over the indicator 122 with a computer pointing device or similar means.

An icon 124 or other indication may also be provided or presented in the process template 100 for creating, maintaining, and controlling any rules associated with automating a user at least partially out of the process flow and automatic completion of at least a portion of the process template 100 pursuant to the rule or rules. Activating or clicking-on the icon 124 using a computer pointing device or other means may present a graphical user interface (GUI) or other mechanism to permit creating, maintaining, editing and controlling activation of a rule or set of rules associated with automating a user at least partially out of the process flow and automatic completion of at least a portion of the process template. As an example, the icon 124 may resemble a wrench as illustrated in FIG. 1C; although, any suitable icon or other symbol to connote its function may be used.

While the process template 100 has been described herein as a form, such as a virtual form, template or graphical user interface, the process template 100 may also be some protocol that defines a process flow or is part of a process flow to perform a task, satisfy a request or provide some other result. Accordingly, automatically completing or partially completing a process template may also mean automatically completing some subtask or function and not merely automatically entering data in a field, selecting between options or some other operation associated with completing a form.

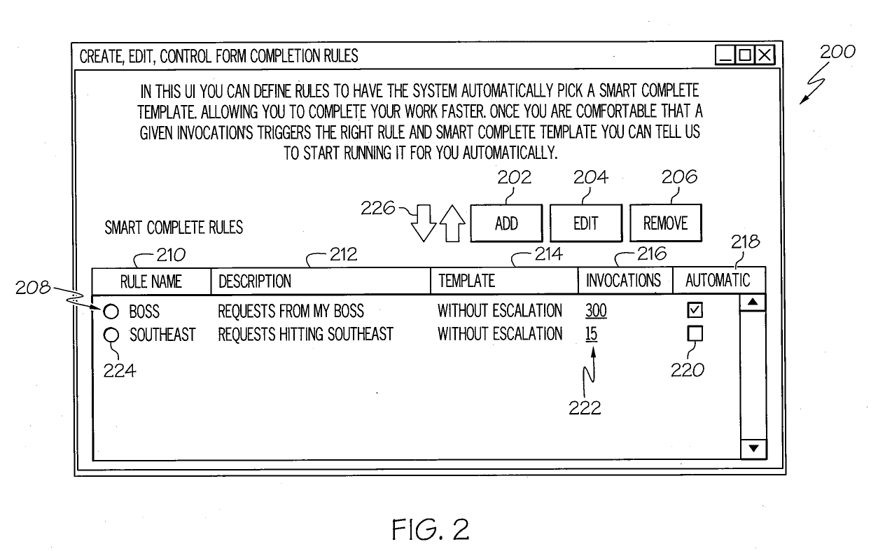

FIG. 2 is an illustration of an example of a graphical user interface (GUI) 200 to create, edit and control activation of one or more rules for automating a user at least partially out of a process flow and for automatically completing at least a portion of the process flow or template, such as template 100, in accordance with an embodiment of the present invention. The GUI 200 may be presented in response to activating of clicking-on the icon 124 in the process template 100 of FIG. 1C. The GUI 200 may include an “Add” control object, button 202 or the like for adding a new rule, an “Edit” control object, button 204 or the like for editing an existing rule, and a “Remove” control object, button 206 or the like for removing an existing rule.

The GUI 200 may include a row 208 corresponding to each rule. Each row 208 may be separated into a plurality of columns containing information about the rule and features for controlling the rule. For example there may be a column 210 for presenting a rule name, a column 212 for providing a rule description, a column 214 for presenting an identification or name of a process template to which the rule is associated, and a column 216 for indicating a number of invocations or a number of process templates in which the rule has been applied. The GUI 200 may also include a column 218 associated with each rule or row 208 to indicate whether the rule has been configured for automatic completion to effectively automate the user out of the process flow. The column 218 may include a control object 220, such as a check box or the like, associated with each rule which may be activated or checked by a computer pointing device or the like to activate the rule. A check mark in the box 220 will indicate that the rule is set to run automatically without the user's involvement and the absence of a check mark will indicate that the rule is not automatic. Accordingly, the box 220 associated with each rule may be toggled to respectively automate the rule (box checked) or not (box unchecked). In this manner, rules can be tested to confirm they are operating properly or consistently before being activated for automatic completion. When a rule is configured for automatic use, the user's task will be answered based upon the identified process template, then the task will be considered done. In this manner no task will appear on a user's in-box.

As previously discussed, an invocation column 216 may be provided to indicate a number 222 of process templates in which the rule has been invoked or applied. This provides an ability for the user to see what is being done on his behalf. The invocation number 222 may also serve as a navigation link to the process templates where the associated rule was invoked or applied to automate a user at least partially out of the process flow and the process template was at least partially completed or populated automatically without user input. A list identifying the process templates in some way may be presented in response to clicking-on the invocation number 222 associated with a rule. A process template may then be accessed or opened and presented for review by clicking-on an identifier for a selected process template in the list.

Other statistics may also be presented in the GUI 200 or another GUI. For example, if the process flow failed for some reason after the automatic completion, the task or template could be highlighted or identified in some way. This may allow the rule or criteria to be re-examined and revised to avoid future errors.

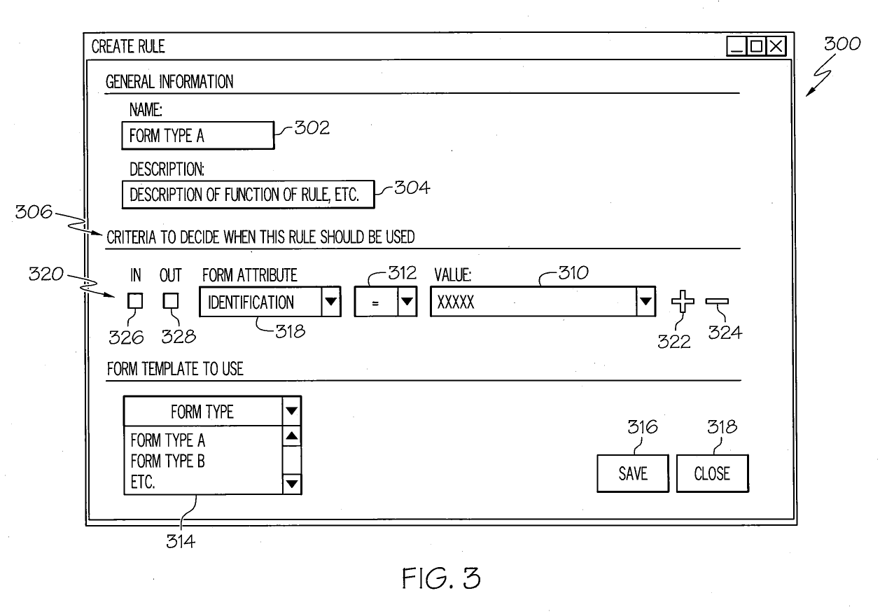

Another control object 224, such as a radio button or the like may be associated with each rule name in column 210. The control object 224 associated with a rule name may be clicked-on or otherwise activated to select a particular rule and then the “edit” button 204 may be clicked-on or activated to present a GUI, such as GUI 300 of FIG. 3, for editing the selected rule. Similarly, the control object 220 may be clicked-on or operated to select a rule and then the “Remove” button 206 may be operated to delete or remove the selected rule.

The rows 208 in GUI 200 make up an ordered list of rules. The rules will be evaluated top-down when attempting to automatically find and apply a captured or saved form template for a given invocation of a form or process template 100. The first row 208 whose criteria 306 from GUI 300 evaluates to “true” will be used to locate the captured or saved form template identified in column 214 to apply to the current form or process template 100. As such, the control object 224 associated with a rule 208 may be clicked-on or otherwise activated to select a particular rule and then the “up” or “down” arrows 226 may be clicked-on or activated to move the rule up or down in the ordered list.

FIG. 3 is an illustration of an example of a graphical user interface 300 to create or edit a rule for automating a user at least partially out of a process flow and for automatically completing at least a portion of the process flow or template in accordance with an embodiment of the present invention. The GUI 300 may include a field 302 to enter a name for the rule and a field 304 to enter a description of the rule. The description may include a function of the rule, purpose or other descriptive or explanatory remarks. The GUI 300 may also include criteria 306 to decide when the rule may be applied or a criteria that should be satisfied before the rule may be applied. The criteria for a rule may be expressed as one or more expressions 320, where each one can be evaluated to a true or false conclusion. More complicated criteria can be achieved by clicking on the “+” icon 322 which would add another expression underneath the current expression. The “−” icon 324 may be used to delete an expression.

Although not shown in FIG. 3, the user may also be able to designate if adjacent expressions should be evaluated together with an “AND” or “OR” operation. In addition, the user can designate for each expression 320 whether or not the expression should be used to filter items in or out of the criteria by clicking-on or activating one of “In” and “Out” buttons or boxes 326 and 328. For more complicated criteria an input field could be provided to enable specification of a Structured Query Language (SQL) query to enable very sophisticated criteria.

An example of criteria 306 may be to define or designate an attribute in the process template and then a relationship to some value for the attribute. For example, the rule may specify that a value in a field corresponding to an attribute in the process template should be greater than, less than, or equal to some value. For this example, the GUI 300 may include a field or drop-down list 308 to identify an attribute in the process template. A value associated with the attribute may be entered in another field 310 and a field or drop-down list 312 may be provided to define the desired criteria for invocation of the rule. For example the rule may specify that the value of the attribute in the process template should be one of equal to, less than, less than or equal to, greater than, or greater than or equal to the value in the rule for the rule to be invoked or applied for applying an existing or predefined form template which may automatically complete at least a portion of the process template and automate the user at least partially out of the process flow.

In accordance with one embodiment of the present invention, data available to define criteria for application of a rule may come from a couple of sources. Fields present in the process template or form may be harvested or collected from a document object model (DOM) and made available. To enable this function on random forms or process templates without overt or extensive coding, a name of a field if present in the DOM may be presented to the user as a “form attribute name” or similar suitable designation. If no name is defined in the DOM, an ID or other identifier may be used. This data may be useful for cases where the rules needed to identify a template are wholly contained within the form itself.

Another possible source of data for criteria for rules may be any “backend data.” For example, an ITSM approval task may enable rules against a Request For Change (RFC) and any of its details being approved, Configuration Items (CIs) associated with the RFC, release records, or any other information in the Change Management Database (CMDB).

The GUI 300 may also include a field or drop-down menu or list 314 to select or designate a process template to which the rule may be applicable or invoked. The GUI 300 may also include control objects, such as a “Save” button 316 to save a new or edited rule and a “Close” button 318 to close the GUI 300. As previously discussed, more complicated criteria can be achieved by clicking on the “+” or “−” button 322 or 324, which will add in or remove a criteria 320.

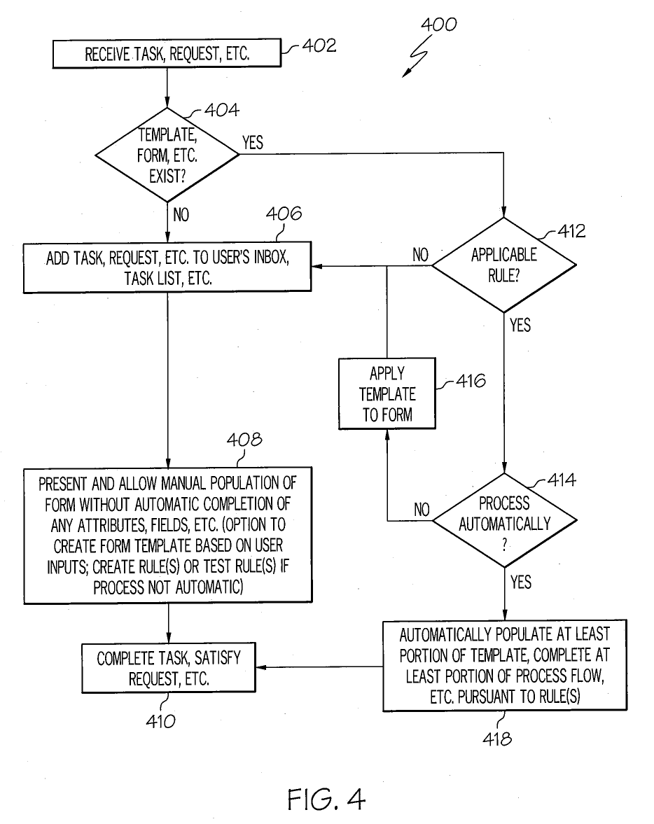

FIG. 4 is a flow chart of an example of a method 400 to automate a user at least partially out of a process flow and to automatically complete at least a portion of the process flow or template in accordance with an embodiment of the present invention. The GUI's 100, 200 and 300 may be generated and presented as part of the method 400. In block 402, a task or request may be received for a user to perform. In block 404, a determination may be made if any process templates, forms, user interface or protocol exists or have been defined for the task or request for the user. The determination in block 404 may be made based the nature of the task or request or based on predefined criteria.

If a determination is made in block 404 that no process template or form exists or is available, the method 400 may advance to block 406 where the task or request may be added to a user's inbox, task list or the like. In block 408, a blank form or process template may be presented for the user to manually populate. Fields associated with each attribute may be completed by the user and selection of any options may be made by the user without any automatic completion. An option may be presented similar to that previously described to create a form template based on the user inputs. One or more rules may also be created to provide criteria for application of the form template in future requests. At some point the user will be done working with the user interface (UI) or form for the task at hand. The method 400 may then advance to block 410 In block 410, the task may be completed or the request satisfied.

Returning to block 404, if a determination is made in block 404 that a process template or form does exist, the method 400 may advance to block 412. In block 412, any rules available for this type of form may be evaluated in priority order until one is found that satisfies the rule's supplied criteria. If no such rule is found processing, the method 400 may advance to block 406 and the method 400 may proceed as previously described. If a rule is found applicable to the form template based on the rule's criteria, the method 400 may advance to block 414.

In block 414 a determination may be made whether or not the rule has been configured to be processed automatically. If the rule is not configured for automatic processing, the method 400 may proceed to block 416. At block 416 the process template identified with the rule identified at block 412 may be applied against the current form and the method 400 may continue to block 406. The method 400 may proceed as previously described, only now when the user views the form, the form will be at least partially filled in based upon the saved template. Although not depicted in the flow chart, when the form has been partially filled pursuant to the method 400, the form that may be presented to the user at block 408 may display the name of the template and other elements or features similar to elements 112, 122, and 124 described with reference to FIG. 1C.

If a determination is made in block 414 to automatically process the request, the method 400 may advance to block 418. In block or module 418, the template identified with the rule identified at block 412 will be applied on the user's behalf. Afterwards the processing flow will continue to block 410, where the user's request is completed as far as the process is concerned. Once the request is completed the method 400 can continue automatically to the next activity.

Accordingly, a user can create rules for automatic completion of his process templates or forms without requiring user input. The user can test the automatic form completion and become comfortable the templates are applied correctly before designating that the system responds to the requests automatically without necessitating interaction on the user's part as described with respect to the control object 220 of FIG. 2. When an activated rule is triggered the appropriate template will be applied and the task or request may be completed on the user's behalf automatically. The task will not appear in the user's “in box” or “to do list” or may be designated as completed. The request or task may then have a predictable outcome with minimal possibility of human error or mis-entry of information or data. The user's efficiency may be improved and more time can be devoted to other tasks.

FIG. 5 is a block diagram of an example of a system 500 to automate a user at least partially out of a process flow and to automatically complete at least a portion of the process flow or template in accordance with an embodiment of the present invention. The system 500 may include a server 502. The server 502 may be an application server and may include a processor for operating or running software or computer programs. A module 504 or modules may be operable on the server 502 or processor of the server to select a process template or form and automatically complete the process template or form pursuant to any rules and to automate a user at least partially out of a process flow similar to that previously described. The method 400 of FIG. 4 may be embodied in the module 504. The GUI 100 of FIGS. 1A-1C may be generated and presented by the module 504.

A module 506 or modules may also be operable on the server 502 or processor to create and edit rules, and to control activation of any rules. The GUI 200 of FIG. 2 and GUI 300 of FIG. 3 may be generated and presented by the module 506. The modules 504 and 506 may be separate modules as illustrated in FIG. 5 or may be combined in a single module or computer program for automatic completion of at least a portion of a process flow or process template or form and to automate a user at least partially out of a process flow similar to that previously described.

A memory 508 may be associated with the server 502 to store process templates or forms 510 and any rules 512 to automate a user at least partially out of a process flow by automatically completing at least a portion of the process flow or process template pursuant to any rules.

The GUIs presentable by the modules 504 and 506 may be presented to a user on a client workstation 514 or the like. The client 514 may access the server and modules 504 and 506 via a network 516. A web server 518 may also be provided for accessing the server 502 or application server. The system may also include a medium 520 that may be a computer program product similar to that previously described. The modules 504 and 506 may be loaded on the server 502 from the medium 520.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to automate a user out of a process flow, comprising:
determining if a process template associated with the process flow exists, wherein the process template comprises a user interface;
determining if a rule exists for automatic completion of at least a portion of the process template to automate the user at least partially out of the process flow; and
at least partially completing the process template automatically without user input in response to an existing rule for the process template, wherein the process template is automatically populated based on a content of the existing rule.

2. The method of claim 1, further comprising applying the existing rule to at least partially complete the process template and to automate the user at least partially out of the process flow in response to a predetermined criteria associated with the existing rule being satisfied.

3. The method of claim 1, further comprising automatically entering a value in a field associated with an attribute in the process template in response to a predetermined criteria associated with the rule being satisfied.

4. The method of claim 1, further comprising presenting an option to create a new rule for at least partial automatic completion of the process flow based on a current process template which is at least partially completed to automate a user at least partially out of the process flow in subsequent processes.

5. The method of claim 1, wherein at least partially completing the process template comprises at least partially completing a form.

6. The method of claim 1, further comprising presenting an indication in the process template that the user has been automated at least partially out of the process flow and that the process template has been at least partially automatically completed based on the existing rule.

7. The method of claim 6, further comprising presenting the existing rule in response to contacting the indication with a computer pointing device.

8. The method of claim 1, further comprising providing an icon in the process template for creating, maintaining, and controlling any rules associated with automating the user at least partially out of the process flow and automatic completion of at least a portion of the process template.

9. The method of claim 8, further comprising presenting a graphical user interface for creating, editing and controlling activation of any rules in response to activating the icon.

10. The method of claim 9, wherein presenting the graphical user interface comprises presenting a control object to control activation of each rule associated with the process template.

11. The method of claim 9, wherein presenting the graphical user interface comprises providing a navigation link to each process template where the user was automated at least partially out of the process flow and the process template was at least partially completed automatically.

12. A system to automate a user out of a process flow, comprising:
a processor;
a module operable on the processor to select a process template based on a task, wherein the template comprises a user interface; and
a module to at least partially complete the process template automatically in response to an existing rule for the process template and to automatically populate the process template based on a content of the existing rule.

13. The system of claim 12, further comprising a module to apply the existing rule in response to a predetermined criteria associated with the rule being satisfied.

14. The system of claim 12, further comprising:
a module to provide an icon in the process template for creating, maintaining, and controlling any rules associated with automating the user at least partially out of the process flow and automatic completion of at least a portion of the process template; and
a module to present an indication in the process template that the user has been automated at least partially out of the process flow and that the process template has been at least partially automatically completed based on the existing rule, wherein the existing rule is presentable in response to contacting the indication with a computer pointing device.

15. The system of claim 14, further comprising a module to present a graphical user interface for creating, editing and controlling activation of any rules in response to activation of the icon, wherein the graphical user interface comprises:
a control object to control activation of each rule associated with the process template; and
a navigation link to each process template where the user was automated at least partially out of the process flow and the process template was at least partially completed automatically.

16. A computer program product to automate a user out of a process flow, the computer program product comprising:
a computer usable medium having computer usable program code embodied therein, the computer usable medium comprising:
computer usable program code configured to determine if a process template associated with the process flow exists, wherein the process template comprises a user interface;
computer usable program code configured to determine if a rule exists for automatic completion of at least a portion of the process template to automate the user at least partially out of the process flow; and
computer usable program code configured to at least partially complete the process template automatically without user input in response to an existing rule for the process template, wherein the process template is automatically populated based on a content of the existing rule.

17. The computer program product of claim 16, wherein the computer usable medium further comprises computer usable program code configured to apply the existing rule to at least partially complete the process template and to automate the user at least partially out of the process flow in response to a predetermined criteria associated with the existing rule being satisfied.

18. The computer program product of claim 16, wherein the computer usable medium further comprises computer usable program code configured to present an indication in the process template that the user has been automated at least partially out of the process flow and that the process template has been at least partially automatically completed based on the existing rule, wherein the existing rule is presentable in response to contacting the indication with a computer pointing device.

19. The computer program product of claim 16, wherein the computer usable medium further comprises computer usable program code configured to provide an icon in the process template for creating, maintaining, and controlling any rules associated with automating the user at least partially out of the process flow and automatic completion of at least a portion of the process template.

20. The computer program product of claim 19, wherein the computer usable medium further comprises computer usable program code configured to present a graphical user interface for creating, editing and controlling activation of any rules in response to activation of the icon, wherein the graphical user interface comprises:
a control object to control activation of each rule associated with the process template; and
a navigation link to each process template where the user was automated at least partially out of the process flow and the process template was at least partially completed automatically.
